(19) United States
(12) Patent Application Publication
(10) Pub. No.: US 2007/0073524 A1
(43) Pub. Date: Mar. 29, 2007

(54) NAVIGATION SYSTEM WITH FUNCTION OF HIKING TRAIL GUIDE AND METHOD FOR HIKING TRAIL GUIDE

(76) Inventor: Kyeong Sub SONG, Icheon-Shi (KR)

Correspondence Address: IPLA P.A., 3580 WILSHIRE BLVD., 17TH FLOOR, LOS ANGELES, CA, 90010, US

(21) Appl. No.: 11/424,857

(22) Filed: Jun. 17, 2006

(30) Foreign Application Priority Data
Jul. 27, 2005 (KR) 10-2005-0068194

(51) Int. Cl. G06F 17/10; G06F 17/00

(52) U.S. Cl. 703/2; 701/208; 707/104.1

(57) ABSTRACT

A navigation system with a function of hiking trail guide, and a method for hiking trail guide are provided. The system includes a mountain map database for storing mountain map data on mountain hiking trail and buildings; an altitude measuring unit for measuring an altitude; a GPS (global positioning system) module for receiving each position signal, calculating a self position, measuring a direction, and outputting information on the self position and the direction; and a controller for receiving position, direction, and altitude information, map-matching the received information, receiving a destination, searching for a path from the calculated position to the received destination, mapping the searched path, and performing the hiking trail guide along the searched path.

### BACKGROUND OF THE INVENTION

1. Field of the Invention

The present invention relates to a navigation system, and more particularly, to a navigation system with a function of hiking trail guide to a mountain destination at the time of climbing a mountain, and a method for hiking trail guide.

2. Description of the Related Art

In general, a navigation system is installed at a vehicle driving on a road, and periodically measures a current position, searches for a path from the measured position to a destination, and performs road guidance along the searched path.

In recent years, as the navigation system is put on a market, a portable navigation system performing the road guidance for a pedestrian is put on the market. However, the portable navigation system uses the same map data as that of a conventional vehicle-centered navigation system.

Accordingly, the conventional navigation system displays a map not including information on a road on which vehicles cannot run, that is, information on a mountain hiking trail.

As described above, the conventional navigation system has a drawback of being incapable of providing guidance for the mountain hiking trail.

Accordingly, due to ignorance of the hiking trail, a hiking novice wanders about, or feels inconvenient in that he/she should climb the mountain together with a mountaineer being well aware of the hiking trail. Further, there is a drawback in that even a mountaineer who has ever climbed a specific mountain several times climbs the mountain along only a familiar hiking trail.

### SUMMARY OF THE INVENTION

Accordingly, the present invention is directed to a navigation system with a function of hiking trail guide, and a method for hiking trail guide, that substantially overcome one or more of the limitations and disadvantages of the conventional art.

One object of the present invention is to provide a navigation system with a function of hiking trail guide to a mountain destination at the time of climbing a mountain, and a method for hiking trail guide.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a navigation system with a function of hiking trail guide, the system including: a mountain map database for storing mountain map data on mountain hiking trail and buildings having longitude, latitude, and altitude information; an altitude measuring unit enabled under a predetermined control signal, and measuring an altitude from a horizontal line; a GPS (global positioning system) module for receiving each position signal from a plurality of GPS satellites, calculating a self position, measuring a direction, and outputting information on the self position and the direction; and a controller for, when a hiking-trail guidance mode is set, receiving information on the position, direction, and altitude, map-matching the received information to the mountain map data, receiving a destination, searching for a path from the calculated position to the received destination, mapping the searched path to the mountain map data, and performing the hiking trail guide along the searched path.

In another aspect of the present invention, there is provided a method for hiking trail guide in a navigation system having a mountain map database for storing mountain map data on mountain hiking trail and buildings having longitude, latitude, and altitude information; an altitude measuring unit for measuring an altitude from a horizontal line; and a GPS (global positioning system) module for receiving each position signal from a plurality of GPS satellites, calculating a self position, measuring a direction, and outputting information on the self position and the direction, the method including the steps of: measuring a current position in a hiking-trail guidance mode; when the measured current position is in a mountain, measuring the position, the direction, and the altitude through the GPS (global positioning system) module and the altitude measuring unit; map-matching the measured position, direction, and altitude to the mountain map data; receiving a destination, searching for a path from the position to the received destination, and matching the searched path to the mountain map data; and performing the hiking trail guide along the searched path.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a navigation system with a function of a hiking trail guide according to the present invention;

FIG. 2 is a flowchart illustrating a method for hiking trail guide in a navigation system according to the present invention; and

FIG. 3 illustrates a concept of hiking-trail map matching based on altitude according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention provides a navigation system capable of guiding a mountaineer for a hiking trail even on a mountain.

The present invention includes a mountain map database for storing mountain map data on the hiking trail having latitude, longitude, and altitude information, and on a building such as a shelter and a resting place positioned around the hiking trail. The hiking trail of the map data has a node provided at a point where a condition is changed. The node has information on a branch point of the hiking trail, or a danger point such as a cliff. It is desirable that the node for the danger point is disposed ahead of a substantial danger point in consideration of erroneous measurement of position.

Further, in view of a characteristic of the mountain, a height of the mountain at which the mountaineer is positioned, that is, altitude information is required and therefore, an altitude measuring unit is provided.

Furthermore, in the present invention, when the measured current position is map matched to the hiking trail, if two adjacent hiking trails are different in altitude, map-matching is performed using a measured altitude, and if the two adjacent hiking trails are identical in altitude, the map-matching is performed in a general map-matching method, that is, in a method of map matching to a hiking trail close to the measured position.

Hereinafter, a construction and an operation of the navigation system with a function of hiking trail guide will be described with reference to the drawings.

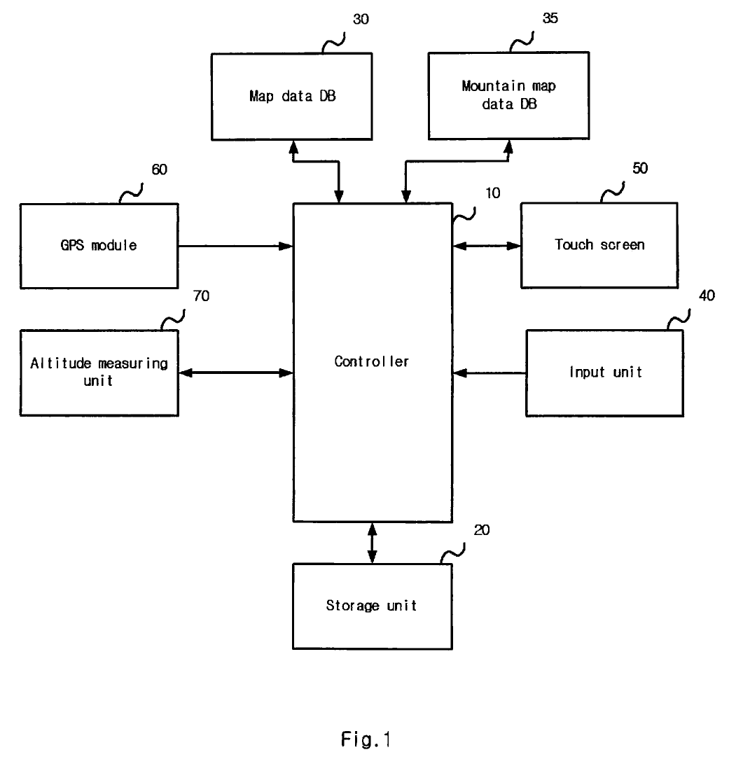

FIG. 1 illustrates the navigation system with the function of the hiking trail guide according to the present invention.

Referring to FIG. 1, the inventive navigation system includes a controller 10, a storage unit 20, a map database (DB) 30, a mountain map DB 35, an input unit 40, a touch screen 50, a global positioning system (GPS) module 60, and the altitude measuring unit 70.

The controller 10 controls a general operation of the navigation system with the function of the hiking trail guide.

The storage unit 20 includes a region for storing a control program for controlling an operation of the navigation system; a region for temporarily storing data generated in execution of the control program; and a region for storing various setting values set by a user.

The map DB 30 stores map data on general terrains excepting for a mountain terrain. In the map data, a terrain, a road, and a building are arranged according to the longitude and latitude information.

The mountain map DB 35 stores map data on the mountain terrain. In the map data, the mountain terrain, the hiking trail, and the building such as the resting place and the shelter around the mountain and the hiking trail are arranged depending on the latitude, the longitude, and the altitude, using the latitude, longitude, and altitude information.

The input unit 40 includes a plurality of keys for controlling an operation of the navigation system or inputting a character, and generates key data on the keys and outputs the generated key data to the controller 10.

The touch screen 50 provides a user graphic interface unit integrated with a display device, such as a liquid crystal display (LCD), on a screen of the display device, and generating and outputting coordinate data of a point pressed by the user to the controller 10.

The GPS module 60 receives position signals from at least three GPS satellites, calculates a self position from the received position signals, measures an advance direction by a gyroscope, and outputs information on the measured advance direction to the controller 10 together with information on the calculated self position.

The altitude measuring unit 70 measures the altitude on the basis of a horizontal line, and outputs the measured altitude to the controller 10.

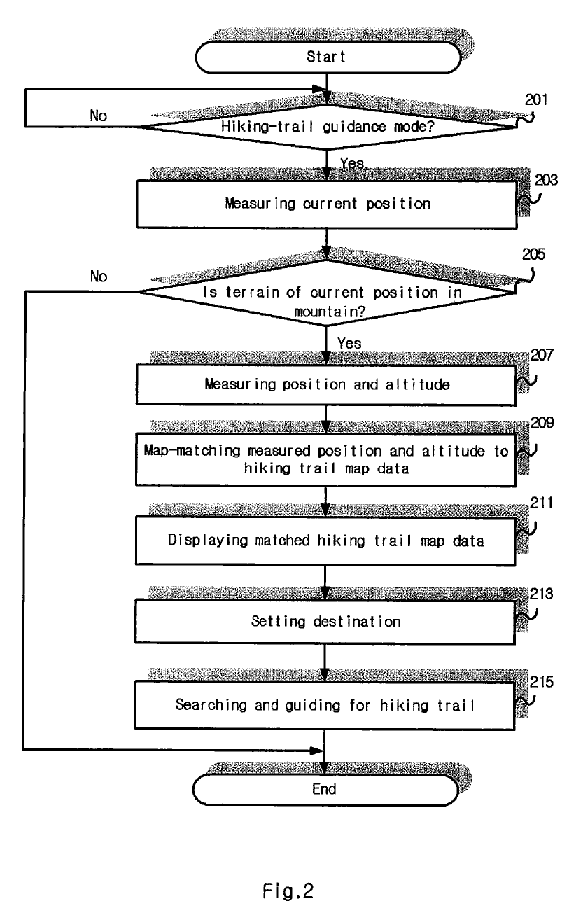

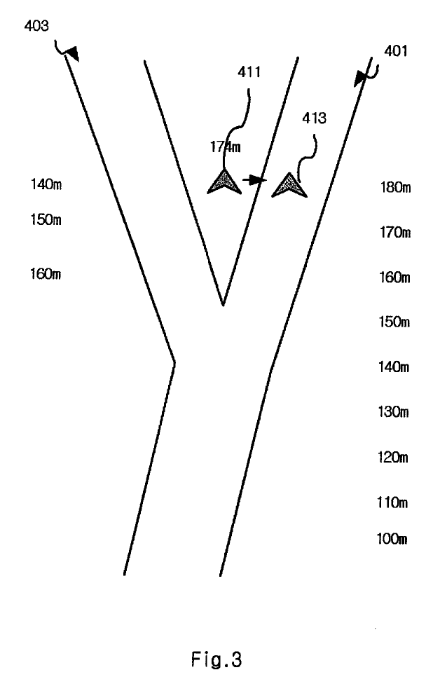

FIG. 2 is a flowchart illustrating a method for the hiking trail guide in the navigation system according to the present invention, and FIG. 3 illustrates a concept of hiking-trail map matching based on the altitude according to the present invention. A description will be made with reference to FIGS. 1 to 3.

In Step 201, the controller 10 determines whether or not to receive the coordinate data or the key data setting a hiking-trail guidance mode, from the input unit 40 or the touch screen 50.

Upon receipt of the coordinate data or the key data setting the hiking-trail guidance mode in the Step 201, in Step 203, the controller 10 measures a current position through the GPS module 60, and in Step 205, determines whether or not the measured current position is in the mountain terrain. Through the Step 205, the hiking-trail guidance mode is prevented from being enabled despite not in the mountain terrain.

If it is determined as the determination result that the current position is in the mountain terrain, in Step 207, the controller 10 enables the altitude measuring unit 70, and measures the position, the advance direction, and the altitude, through the GPS module 60 and the altitude measuring unit 70. In Step 209, the controller 10 map matches the measured position, the advance direction, and the altitude to the mountain map data.

In the map matching, as shown in FIG. 3, there exist a first hiking trail 401, and a second hiking trail 403 adjacently disposed thereto. If the measured position is at a position 411, the first and second hiking trails 401 and 402 are compared in altitude on a line vertical to the same advance direction, and are determined whether or not to be identical within a predetermined tolerance. As shown in the drawings, the first hiking trail 401 is an uphill way on the basis of the branch point, and the second hiking trail 403 is a downhill way on the basis of the branch point.

If the first and second hiking trails 401 and 403 are different in altitude, the controller 10 sequentially compares the measured altitude (174 meter), an altitude (180 meter) of the first hiking trail 401, and an altitude (140 meter) of the second hiking trail 403, and map matches to a hiking trail having a closer altitude, that is, to the first hiking trail 401 of FIG. 3.

However, if the first and second hiking trails 401 and 402 are identical in altitude within a predetermined tolerance, the controller 10 performs the map-matching in a general map matching method.

Upon the map-matching through the method, in Step 211, the controller 10 displays the mountain map data map-matched in position, on the touch screen 50.

After the displaying, in Step 213, the controller 10 sets a destination by the user and, in Step 215, searches for a path from the current position to the destination and performs the hiking trail guide along the searched path.

As described above, the present invention has an advantage in that, since the mountaineer can be guided even for the hiking trail in the mountain, even the novice mountaineer can set the various paths and climb the mountain.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A navigation system with a function of hiking trail guide, the system comprising:
a mountain map database for storing mountain map data on mountain hiking trail and buildings having longitude, latitude, and altitude information;
an altitude measuring unit enabled under a predetermined control signal, and measuring an altitude from a horizontal line;
a GPS (global positioning system) module for receiving each position signal from a plurality of GPS satellites, calculating a self position, measuring a direction, and outputting information on the self position and the direction; and
a controller for, when a hiking-trail guidance mode is set, receiving information on the position, direction, and altitude, map-matching the received information to the mountain map data, receiving a destination, searching for a path from the calculated position to the received destination, mapping the searched path to the mountain map data, and performing the hiking trail guide along the searched path.

2. The system according to claim 1, wherein, when the calculated position is map matched, if two adjacent hiking trails are different in altitude, the map-matching is performed using the measured altitude information.

3. The system according to claim 2, wherein, if the two adjacent hiking trails are identical in altitude, map-matching to a hiking trail close to the calculated position is performed.

4. A method for hiking trail guide in a navigation system having a mountain map database for storing mountain map data on mountain hiking trail and buildings having longitude, latitude, and altitude information; an altitude measuring unit for measuring an altitude from a horizontal line; and a GPS (global positioning system) module for receiving each position signal from a plurality of GPS satellites, calculating a self position, measuring a direction, and outputting information on the self position and the direction, the method comprising the steps of:
measuring a current position in a hiking-trail guidance mode;
when the measured current position is in a mountain, measuring the position, the direction, and the altitude through the GPS (global positioning system) module and the altitude measuring unit;
map-matching the measured position, direction, and altitude to the mountain map data;
receiving a destination, searching for a path from the position to the received destination, and matching the searched path to the mountain map data; and
performing the hiking trail guide along the searched path.

5. The system according to claim 4, wherein if two adjacent hiking trails are different in altitude at the time of map matching, the map-matching is performed using the measured altitude.

6. The system according to claim 5, wherein if the two adjacent hiking trails are identical in altitude, map-matching to a hiking trail close in position is performed.
